(19) United States
(12) Patent Application Publication
(10) Pub. No.: US 2001/0041989 A1
(43) Pub. Date: Nov. 15, 2001

(54) System for detecting and preventing distribution of intellectual property protected media

(76) Inventors: Andrew J. Vilcauskas JR., Tualatin, OR (US); Robert D. Bloodgood III, Portland, OR (US); Matthew G. Middleton, Portland, OR (US)

Correspondence Address: MILLER NASH LLP, ATTN: KAREN DANA OSTER, 111 S.W. FIFTH AVENUE, SUITE 3500, PORTLAND, OR, 97204-3699, US

(21) Appl. No.: 09/853,850

(22) Filed: May 10, 2001

Related U.S. Application Data
(60) Provisional application No. 60/203,355, filed on May 10, 2000.

(51) Int. Cl. G06F 17/60; G06F 17/30; G06F 15/16; G06F 7/00; H04K 1/00; H04L 9/00; G06F 17/00

(52) U.S. Cl. 705/1; 707/3; 709/200; 709/249; 705/51; 705/57; 707/104.1; 707/10

(57) ABSTRACT

The present invention is a system for detecting and preventing intellectual property infringement over a communication medium. At least one service module is preferably used to interface with a communication medium and scan for potentially infringing content. In a preferred embodiment, service modules are capable of passing reference addresses of potential infringers to an infringement-identification module that determines whether infringing content is present. Reference addresses of infringers are preferably passed to a cease-and-desist module that attempts to remove the infringing content.

The present application is based on and claims priority from provisional application Ser. No. 60/203,355, filed May 10, 2000.

### BACKGROUND OF THE INVENTION

The method and apparatus of the present invention relate to the detection and prevention of electronic intellectual property infringement on digital and analog networks.

A myriad of communication methods and schemes (“services”) can be used on Internet transport layers. Some exemplary services include IRC (Internet Relay Chat), FTP (File Transfer Protocol), WWW (World Wide Web), Usenet, and e-mail. There are countless unique sites using the various services available. Piracy occurs on all known services via all known data transfer services.

On the minor end of the infringement spectrum, piracy can be as simple as copying a DVD, floppy disk, or CD-ROM and transferring the copied media to another person. This type of minor piracy, while relatively commonplace, is nearly impossible to control. Control may be exercised over minor piracy by local authorities.

On the serious end of the infringement spectrum, whole nations have flagrantly disregarded intellectual property rights altogether. On May 1, 1996, the U.S. Embassy Press Page featured an article stating that “U.S. losses due to copyright piracy in China in 1995 amounted to $2,320 million.” (“Industry Hails U.S. Labeling China as Software Pirate”; at http://www.usis-israel.org.il/publish/press/trade/archive/may/et1_{—}5-2.htm.)

But in the middle of the infringement spectrum is the Internet. Electronic piracy includes infringement, theft, illegal copying, and distribution of electronically stored and transmitted intellectual property. Intellectual property vulnerable to electronic piracy may include software, music, film, video, art, trademarks, and copyrighted text. It is virtually impossible to produce a software program or other form of digital media without worldwide vulnerability to illicit copying and dissemination by underground piracy. The current state of the Internet brings new attention to piracy because of the Internet's capacity to store and transfer large volumes of data, its ubiquitous distribution channels, and the available speeds of data transfer. Piracy of intellectual property is also likely to occur on future broadband successors to the Internet.

Further, inexpensive disk space is available for storing pirated material. Large hard disks are now available at relatively low cost. Prices have also decreased on floppy diskette drives, CD-ROM drives, zip disks, and tape backup units. Free web sites with 5-50 megabytes of storage capacity are readily available. College students are typically allocated server space for their student accounts.

An increase in the speed of data transfer is also making pirating easier. For example, cable modems are installed in hundreds of thousands of homes across the U.S., and DSL (Digital Subscriber Line) services are being actively marketed across the nation at low cost. Each web site and personal computer connected to the Internet is a single node in a pervasive worldwide network of computers, and each offers a potential portal for pirating media.

The most common act of piracy is reproducing copyrighted media, usually by a person (or persons) known as a “cracker.” If the media is protected by a copy-prevention scheme, crackers often circumvent copy protection and distribute pirated media even before it is fully distributed by legitimate vendors.

### BRIEF SUMMARY OF THE INVENTION

The present invention is directed to a system for detecting and preventing intellectual property infringement over a communication medium. At least one service module interfaces with a communication medium and scans for potentially infringing content. Exemplary service modules include Usenet, WWW, FTP, IRC, Hotline, and e-mail modules adaptable to respective communication services used on the Internet.

In a preferred embodiment, service modules are capable of passing reference addresses of potential infringers to an infringement-identification module that determines whether infringing content is present. If infringing content is present, the reference addresses are preferably passed to a cease-and-desist module that attempts to remove the infringing content from the communication medium.

In one preferred embodiment, a reporting module summarizes the infringements identified by the infringement-identification module and may also summarize attempts made by the cease-and-desist module to stop infringement. The reporting module may be capable of reporting activity of the other modules.

The present invention also includes a preferred method of detecting and preventing intellectual property infringement over a communication medium.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWING

FIG. 1 is a block diagram of main modules included in one preferred embodiment of the present invention.

FIG. 2 is a block diagram of one preferred embodiment of the data processing system and related modules of FIG. 1.

FIG. 3 is a block diagram of an exemplary Usenet module of the present invention connected to other service modules and to a data processing system.

FIG. 4 is a block diagram of an exemplary FTP module of the present invention connected to other service modules and a data processing system.

FIG. 5 is a block diagram of an exemplary WWW module of the present invention connected to other service modules and to a data processing system.

FIG. 6 is a block diagram of an exemplary IRC module of the present invention connected to other service modules and to a data processing system.

FIG. 7 is a block diagram of a preferred method of the present invention.

### DETAILED DESCRIPTION OF THE INVENTION

The present invention may be used for preventing infringement and piracy of electronically stored and transmitted intellectual property, including but not limited to software, music, film, video, art, trademarks, and copyrighted text.

The present invention is a modular, extensible, scanning, and analysis system designed to locate and positively identify piracy on digital and analog networks. The system includes a central data store, core modules, and service modules. In a preferred embodiment, the core modules process and transfer data between each other and between service modules and a central data store. The service modules provide interfaces to the various types of network services. For example, IRC, FTP, W-WW, Usenet, and email Internet communication methods use corresponding service modules. The present invention may also include analog modules for tracing the transmission of intellectual property on analog systems such as telecom systems.

The modular and extensible nature of the system allows flexibility for the development of future Internet communication methods. The system is easily extensible to enhance interoperability with other tracking and/or analysis systems, and new service modules may be written or created for newly developed protocols. The expansion and development of the Internet may produce new opportunities for copyright piracy. The present invention may be expanded with new modules to interface with any Internet communication methods that may become vulnerable to copyright piracy. Alternately, if the various Internet communication methods merge into a single standard, the present invention may be embodied in fewer modules or in a single module.

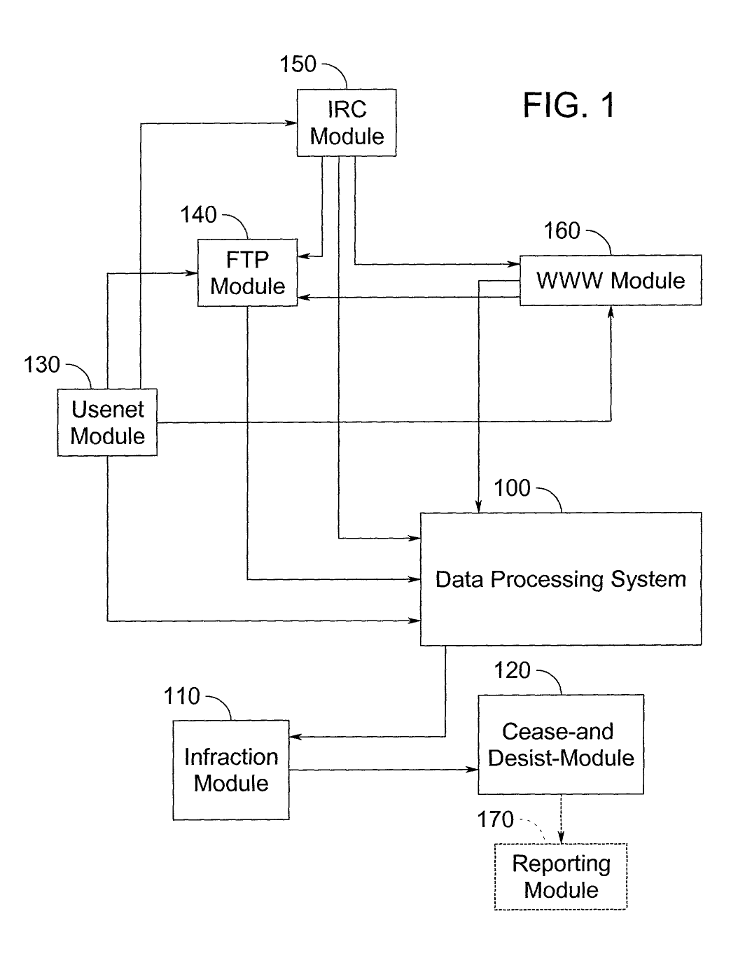

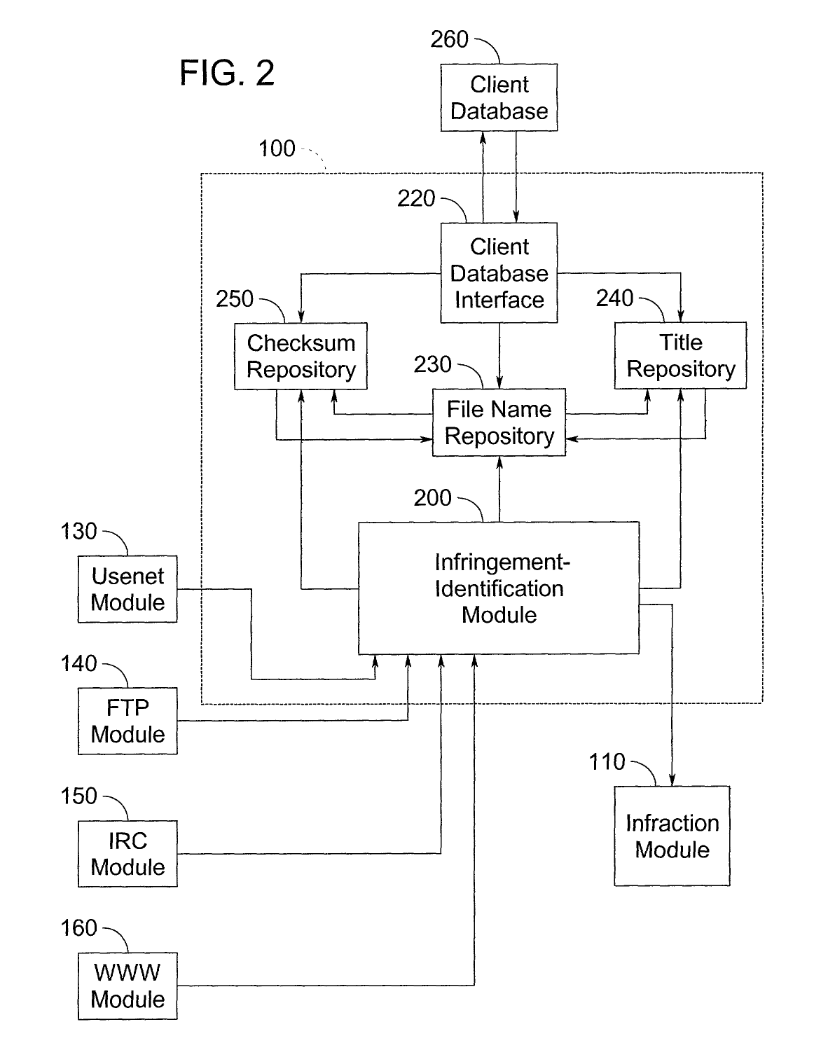

As shown in FIGS. 1 and 2, exemplary core modules may include but are not limited to at least one data processing system 100 and at least one optional reporting module 170. The data processing system 100 may include, for example, at least one infringement-identification module 200, at least one infraction module 110, and at least one cease-and-desist module 120. It should be noted that these modules or their respective functions may be incorporated into any number of modules.

The data processing system 100 preferably has the capability of connecting directly to a client database 260 to retrieve lists of titles for which the client desires protection from piracy. The complete database of media titles to be protected is preferably shared among all (or most of) the service modules of the present invention. The data processing system 100 may also be responsible for maintaining a database of known infringement patterns, for example, file-naming schemes that identify a distribution of a particular copyrighted title.

The infringement-identification module 200 of the data processing system 100 preferably compares titles, checksums, file names, directory names, file path names, file sizes, and other context information of potentially infringing sources to respective lists from the client database 260. The data processing system 100 may periodically refresh title listings from the client database 260 under a service agreement that includes classes of products or complete product scans.

The infringement-identification module 200 tracks web sites or groups of electronic files suspected of having pirated content and compiles an infractors list to pass to the infraction module 110. The infractors list may identify the suspected infringement using a reference address. In one preferred embodiment, the infringement-identification module 200 uses a client database interface 220 to produce at least one file name repository 230, at least one title repository 240, and/or at least one checksum repository 250 from the client database 260 of intellectual property to be protected. The infringement-identification module 200 may optionally use comparison algorithms, data-mining programs, software robots, and other virtual machines to compare the contents of the client database 260 to content from Internet web sites, files, and other suspected piracy sources. A tentative infractors list of suspected infractors' sites and/or files containing content potentially pirated from the client is sent to an infraction module 110. The infringement-identification module 200 may be part of the data processing system 100 as shown in FIG. 1, it may be part of the infraction module 110 (not shown), or it may be a separate module or modules.

The infractors list of potentially offending sites and/or files is reviewed by an infraction module 110 to positively identify pirated contents. In one embodiment, a trained operator may participate in the function performed by an infraction module 110. Alternatively, the comparison between the client's protected work and the potentially offending sites and/or files is done electronically using a comparison algorithm. The comparison algorithm preferably allows a predetermined percentage of variation depending on the client's needs. Based on results from the infraction module 110, content either is positively identified as infringing, in which case it is added to data repositories of known pirated content 230, 240, 250, or is identified as noninfringing, in which case it is ignored. Material identified as positively infringing is also forwarded to the cease-and-desist module 120 for further processing.

The cease-and-desist module 120 is an electronic and/or human component of the system in which a report is compiled containing positively identified infractions, the site(s) and service(s) on which the piracies occurred, and known contact information about the source(s) of piracy. Administrators of accounts responsible for (or other responsible parties, e.g., the infringer's ISP or bandwidth provider) piracy may be contacted automatically, for instance by e-mail, and an attempt may be made to terminate the site or account in question. In one embodiment, the client may request that a printed letter be used to contact parties responsible for piracy. The cease-and-desist module 120 may also assemble and issue legal notices to the responsible parties.

The optional reporting module 170 may be included in any of the preferred embodiments. The reporting module 170 summarizes piracy results for a client. In one preferred embodiment, the reporting module 170 automatically refreshes a roster of infringement incidents. For example, for a known infringer, the present invention may post and update an ongoing roster of infringement incidents. Alternate embodiments of generated reports might include hard copies of reports mailed through traditional means, e-mail reports, and/or an updated list of offending web sites.

Service modules, such as exemplary Usenet modules 130, FTP modules 140, IRC modules 150, and WWW modules 160, scan specific network communication services, participate in central title management, and perform cross-service processing. Central title management of the complete database of media titles to be protected is preferably shared by all service modules.

Service modules may perform cross-service processing. Because content in one type of service may contain references to another type of service. For example, a web site may contain a link to an FTP server. Likewise, a message posted on an IRC channel or Usenet newsgroup may mention a web site or may contain an advertisement with a hyperlink to a web site. The content in one type of service is cross-checked for links to other types of services and passed to respective service modules for follow-up processing.

A detailed description of some of the exemplary service modules follows. These examples are meant to be exemplary and not to limit the scope of the invention.

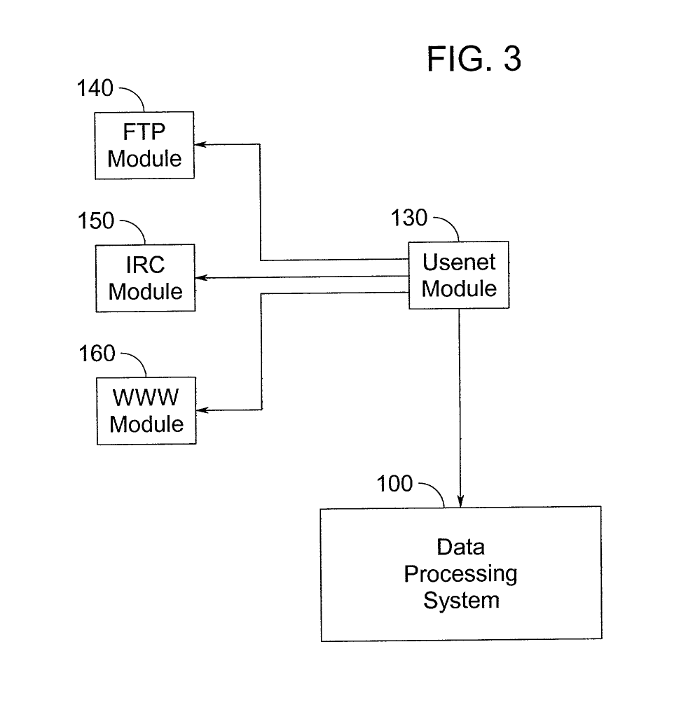

As shown in FIG. 3, a Usenet module 130 monitors Usenet news groups, or “news.” Usenet is a system by which messages posted on a single news server are propagated to many similar news-servers worldwide. The messages are arranged in a hierarchy that reflects the topic of a news group, for example rec.boats, sports.hockey, and sci.physics. The majority of news groups are moderated, and creation of a new group must pass a review. The “alt.*” category, however, is unmoderated. New “alt” groups can be created by posting a single control message to a news-server. Binary files of pirated intellectual property are often divided into smaller pieces, posted to pirate news groups (“warez groups”), and automatically distributed worldwide.

The Usenet module 130 finds pirated content by connecting to highvolume news-servers and scanning message summaries for information such as size, file name, and message titles. Messages are filtered by the data processing module 100 for evidence of infringing content. The Usenet module 130 may perform cross-service referrals by passing links referring to other communication services to their respective service modules for follow-up processing. For example, FTP advertisements may be sent to the FTP module 140, WWW advertisements may be sent to the WWW module 160, and IRC channels may be sent to the IRC module 150. It should be noted that the Usenet module 130 may receive links from the other service modules.

Usenet infringements may be automatically removed by sending a specially formatted news message (“control message”) containing commands to delete offending material from the news-server. These control messages, also called cancel messages, are propagated automatically worldwide, in the same fashion as the original content.

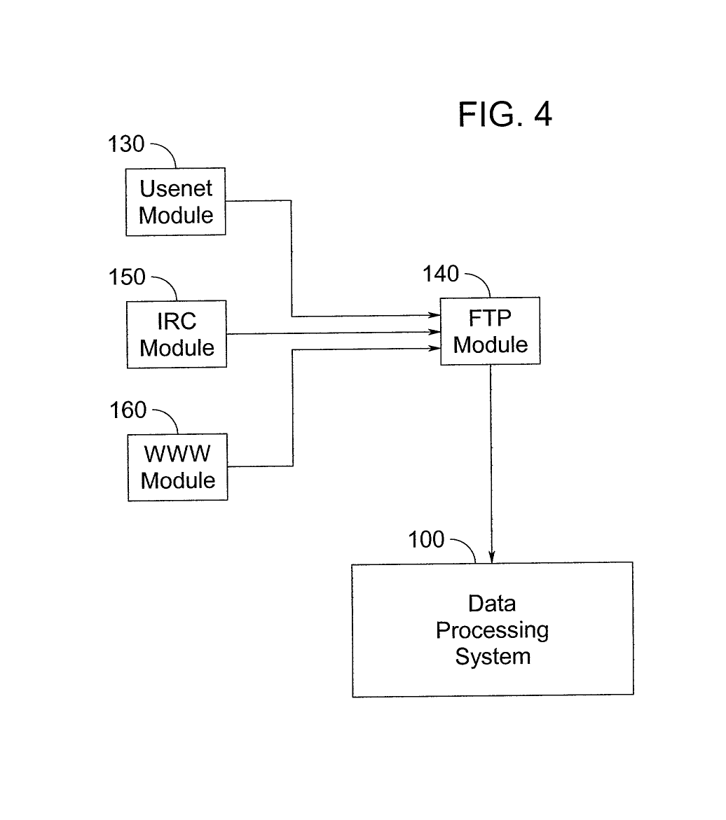

FIG. 4 shows an FTP module 140 that is able to traverse hierarchical file systems to search for infringing content. Not only are individual files scanned for title and checksum matches, but folder names (e.g. directory listings) under which files are stored are also scanned. The FTP module may identify files based on any combination of file name(s), directory name, size, fingerprint, and other identifying attributes. Files of copyrighted titles are often broken up into smaller files for downloading convenience, but the name of the subdirectory in which they are stored often discloses the full name of the title being sought. Potentially infringing material found by the FTP module is passed to the infringement-identification module 200. The FTP module 140 may send and receive links to and from the Usenet module 130, the WWW module 160, the IRC module 150, and other service modules for cross-service follow-up processing.

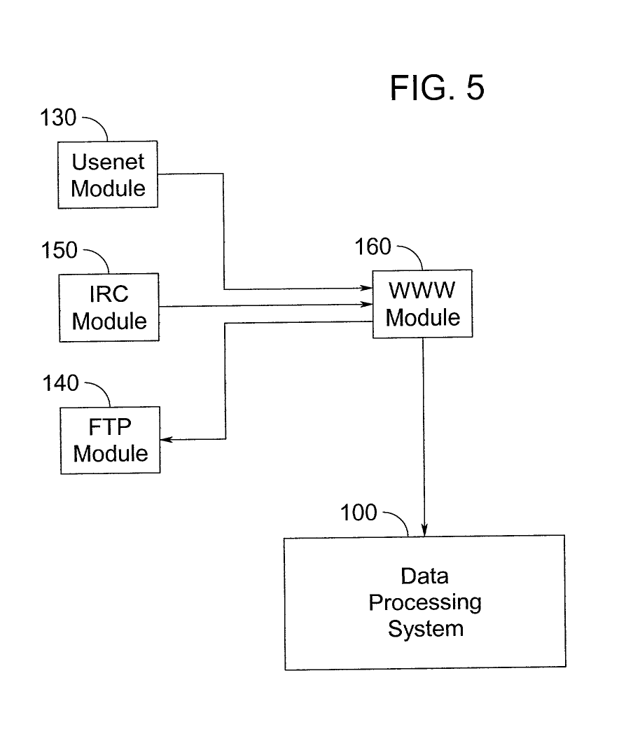

As shown in FIG. 5, a WWW module 160 scans the World Wide Web for infringing web sites. Specifically, the WWW module scans for links to web sites featuring downloadable media. For example, the WWW module 160 scans HEAD requests for file size, title, and checksum. Media links are identified by title and binary checksum, and sent to the data processing module 100 for further action. Links to other web sites are added to the list of sites to review and followed in order. In one preferred embodiment, a set of filtering rules may restrict the depth of traversal so that the entire Internet is not scanned, and nonpirate sites such as legitimate advertisers are disregarded. Potentially infringing material found by the WWW module 160 is preferably passed to an infringement-identification module 200. The WWW module in turn receives referrals from other services' modules. WWW advertisements may be received from the Usenet module 130 and the IRC module 150. The WWW module 160 may pass FTP links to the FTP module 140.

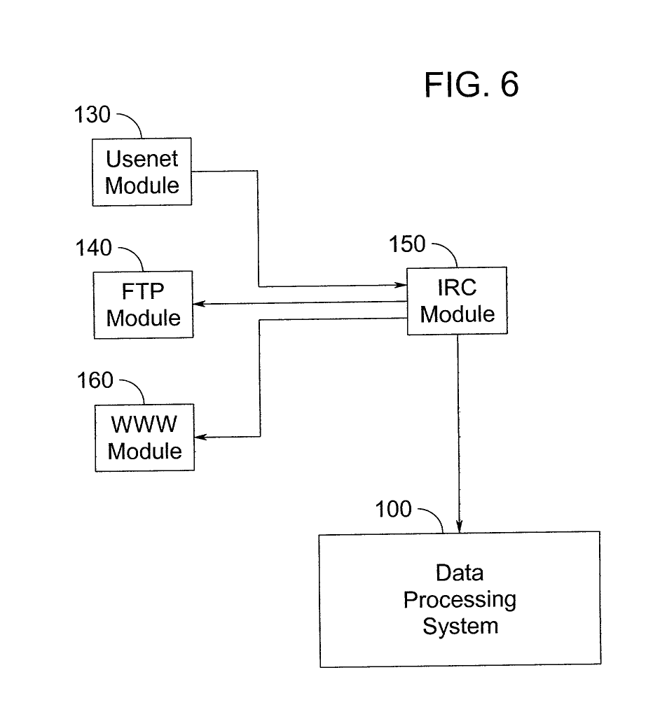

As shown in FIG. 6, an IRC module 150 joins IRC channels with known pirate activity and monitors message traffic. Various methods of file transfer offered on IRC include: XDCC offerbots and fserves. XDCC offerbots and fserves provide automatic downloads, available by sending a special title request command to an IRC client operating the offerbot. Channel invitations, such as “come to #mychannel for more warez!”, are accepted by joining the channel. The IRC module 150 may search lists of titles that are periodically offered by the offerbot. The IRC module 150 also relies on cross-service references from the Usenet module 130 and other service modules. The IRC module 150 may send FTP advertisements to the FTP module 140 and WWW advertisements to the WWW module 160. For fserves, a DCC (direct client connection) is made to the fserve, and an interface is established that is similar to FTP protocol so that scanning and identification can be handled directly by the FTP module 140. Potentially infringing material found by the IRC module 150 is passed to the infringement-identification module 200 of the data processing system 100.

The present invention is not limited to the service modules described above. For example, a Hotline module (not shown) may interface with the Hotline system by contacting Hotline trackers, which are network servers listing individual Hotline clients. Hotline clients offer downloadable content from their local systems. Once an individual connection is made to a system offering files, the Hotline interface is nearly identical to FTP in nature and can be handled directly by the FTP module 140. Potentially infringing material found by a Hotline module can then be passed to the infringement-identification module 200. Other exemplary service modules include an e-mail service module, a TCP/IP service module, a Novell NetWare service module, a LANtastic Network service module, a Gopher service module, a Gnutella service module, an HTTP service module, a Telnet service module, an “rlogin” service module, a finger service module, a wide-area network service module, and an intranet service module.

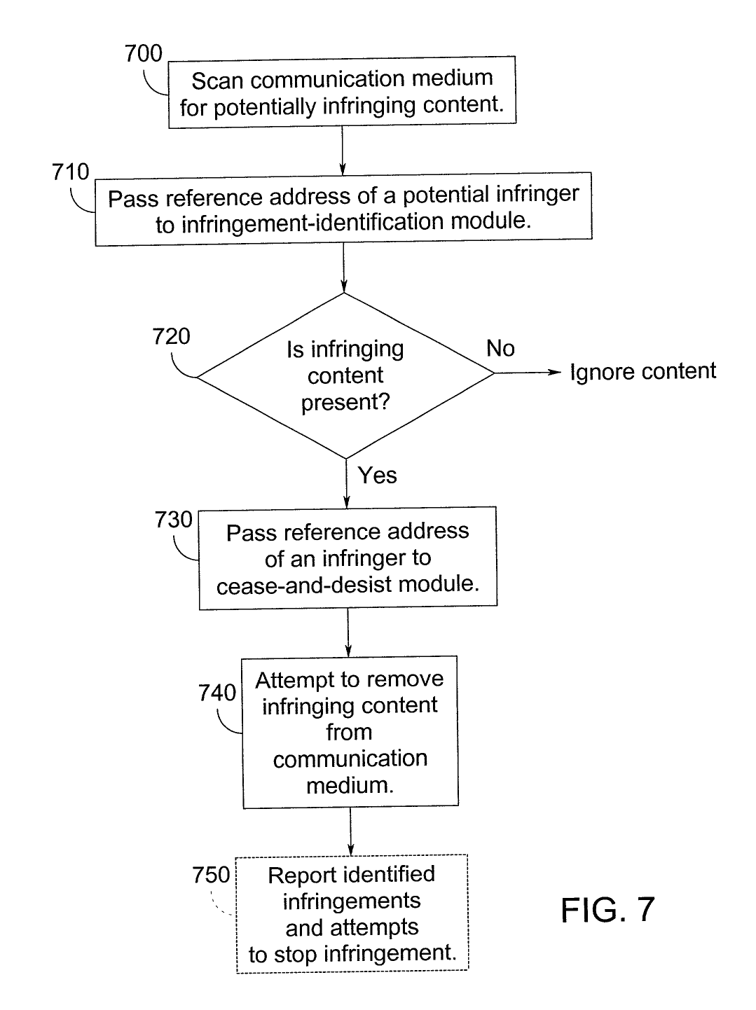

FIG. 7 shows a preferred method of the present invention. Although this method is described as a series of steps, it should be noted that the steps may be performed concurrently and/or in multiple and various orders. The first step is preferably scanning a communication medium for potentially infringing content 700. A reference address of a potential infringer is then passed to an infringement-identification module 710. Next, the infringement-identification module determines whether infringing content is present 720. If infringing content is present, the reference address of an infringer is passed to a cease-and-desist module 730. If infringing content is not present, the content passed by a service module to an infringement-identification module 200 is preferably ignored. Alternately, the information may be logged and/or no data set to the infringement-identification module. The cease-and-desist module attempts to remove the infringing content 740. The activity of the cease-and-desist module and/or the infringement-identification module is optionally reported to a system operator or intellectual property owner 750.

New network services appear every day. The modular nature of the present invention is such that new service modules can be designed and added for new services that may carry copyrighted material. The capabilities of the present invention should not be limited to the specific examples above, and the present invention is not limited to the Internet. Service modules can be created or altered to scan for infringing material over any network.

The terms and expressions that have been employed in the foregoing specification are used as terms of description, not of limitation, and are not intended to exclude equivalents of the features shown and described or portions of them. The scope of the invention is defined and limited only by the claims that follow.

What is claimed is:

1. A system for detecting and preventing infringement of intellectual property over a communication medium, said system comprising:
(a) a database of search intellectual property;
(b) at least one service module for interfacing with said communication medium;
(c) a data processing system interfacable with said at least one service module and said database;
(i) said data processing system for accessing said database to retrieve said search intellectual property;
(ii) said data processing system for accessing said communication medium using said at least one service module;
(iii) said data processing system for searching for said search intellectual property over said communication medium; and
(iv) said data processing system for detecting possible infringements of said intellectual property to be protected and for producing a possible infractors list;
(d) an infraction module interfacable with said data processing system;
(i) said infraction module for receiving said possible infractors list from said data processing system; and
(ii) said infraction module verifying infringements and producing an actual infractors list; and
(e) a cease-and-desist module interfacable with said infraction processing system;
(i) said cease-and-desist module for receiving said actual infractors list from said infraction module; and
(ii) said cease-and-desist module for attempting to stop said infringements over said communication medium.

2. The system of claim 1, said at least one service module selected from the group of service modules consisting of:
(a) a Usenet service module;
(b) a news group service module;
(c) an FTP service module;
(d) an IRC service module;
(e) a WWW service module;
(f) a Hotline service module;
(g) an e-mail service module;
(h) a TCP/IP service module;
(i) a Novell NetWare service module;
(j) a LANtastic Network service module;
(k) a Gopher service module;
(l) an HTTP service module;
(m) a Telnet service module;
(n) an rlogin service module;
(o) a finger service module;
(p) a wide-area network service module;
(q) an intranet service module; and
r) a Gnutella module.

3. The method of claim 1 wherein said at least one service module is a plurality of service modules, at least one of said plurality of service modules interfacable with another at least one of said plurality of service modules to provide a communication link to a possible infractor.

4. The system of claim 1, said data processing system further comprising at least one module selected from the group of modules consisting of:
(a) at least one database interface module;
(b) at least one file name repository module;
(c) at least one directory name repository module;
(d) at least one file path repository module;
(e) at least one checksum repository module;
(f) at least one file size repository module; and
(g) at least one reference address repository module.

5. The system of claim 1, said data processing system further comprising at least one infringement-identification module interfacable with said at least one service module and said infraction module:
(a) said infringement-identification module receiving content input from said at least one service module;
(b) said infringement-identification module comparing said content input to said search intellectual property; and
(c) said infringement-identification module outputting matches between said content input and said intellectual property to said infraction module.

6. The system of claim 5, said content input further comprising at least one listing selected from the group of listings consisting of:
(a) Usenet traffic listings;
(b) FTP content listings;
(c) IRC offering listings;
(d) WWW site listings;
(e) Hotline listings; and
(f) e-mail content listings.

7. The system of claim 1, said system further comprising a reporting module interfacable with said infraction module, said reporting module summarizing infringements identified by said infraction module.

8. The system of claim 1, said system further comprising a reporting module interfacable with said cease-and-desist module, said reporting module summarizing attempts made by said cease-and-desist module to stop said infringements.

9. A system for detecting and preventing intellectual property infringement over a communication medium, said system comprising:
(a) at least one service module for scanning communication medium services for potentially infringing content;
(b) said service module capable of passing a reference address from a communication medium service having potentially infringing content;
(b) an infringement-identification module for receiving said reference address;
(c) said infringement-identification module capable of determining whether potentially infringing content is present;
(d) an infraction module for receiving said reference address;
(e) said infraction module capable of identifying infringing content;
(f) a cease-and-desist module for receiving said reference address; and
(g) said cease-and-desist module capable of attempting to remove said infringing content.

10. The system of claim 9 further comprising a reporting module for reporting attempts by said cease-and-desist module to remove infringing content.

11. The method of claim 9 wherein said at least one service module is a plurality of service modules, at least one of said plurality of service modules interfacable with another at least one of said plurality of service modules to provide a communication link to a possible infractor.

12. A system for detecting and preventing intellectual property infringement over a communication medium, said system comprising:
(a) at least one service module for scanning said communication medium for potentially infringing content, said at least one service module capable of passing a reference address of a potential infringer;
(b) an infringement-identification module for receiving said reference address of a potential infringer, said infringement-identification module capable of determining whether infringing content is present and passing a reference address of an infringer; and
(c) a cease-and-desist module for receiving said reference address of an infringer and at least attempting to remove said infringing content.

13. The system of claim 12 further comprising a reporting module for reporting the activity of said cease-and-desist module.

14. The method of claim 12 wherein said at least one service module is a plurality of service modules, at least one of said plurality of service modules interfacable with another at least one of said plurality of service modules to provide a reference address of a potential infringer.

15. A method for detecting and preventing intellectual property infringement over a communication medium, said method comprising the steps of:
(a) scanning said communication medium for potentially infringing content;
(b) passing a reference address of a potential infringer to an infringement-identification module;
(c) determining whether infringing content is present;
(d) passing a reference address of an infringer to a cease-and-desist module; and
(e) attempting to remove said infringing content.

16. The method of claim 15 further comprising the step of reporting the results of said scanning step, determining step, and attempting to remove step to an owner of intellectual property.

17. The method of claim 15 further comprising the step of passing a reference address between a plurality of scanning modules to enhance said scanning step.

18. A system for detecting and preventing intellectual property infringement over a communication medium, said system comprising:
(a) means for scanning said communication medium for potentially infringing content;
(b) means for passing a reference address of a potential infringer;
(c) means for identifying infringement comprising:
(i) means for receiving said reference address of a potential infringer;
(ii) means for determining whether infringing content is present; and
(iii) means for passing a reference address of an actual infringer; and
(d) means for receiving said reference address of an actual infringer and at least attempting to remove said infringing content.
